(19) United States
(12) Patent Application Publication
(10) Pub. No.: US 2016/0085445 A1
(43) Pub. Date: Mar. 24, 2016

(54) METHOD OPERATING RAID SYSTEM AND DATA STORAGE SYSTEMS USING WRITE COMMAND LOG

(71) Applicants: JU PYUNG LEE, INCHEON (KR); JOO YOUNG HWANG, SUWON-SI (KR); JUNG MIN SEO, SEONGNAM-SI (KR)

(72) Inventors: JU PYUNG LEE, INCHEON (KR); JOO YOUNG HWANG, SUWON-SI (KR); JUNG MIN SEO, SEONGNAM-SI (KR)

(21) Appl. No.: 14/800,728

(22) Filed: Jul. 16, 2015

(30) Foreign Application Priority Data
Sep. 18, 2014 (KR) 10-2014-0124532

(51) Int. Cl. G06F 3/06

(52) U.S. Cl. CPC G06F 3/061; G06F 3/0659; G06F 3/0685

(57) ABSTRACT

A method of operating a data storage device includes receiving a log start command from a controller, generating a log for write commands communicated from the controller in response to the log start command, storing the log in a memory, receiving a log read command from the controller, and communicating the log stored in the memory to the controller in response to the log read command.

### CROSS-REFERENCE TO RELATED APPLICATIONS

This application claims priority under 35 U.S.C. §119(a) from Korean Patent Application No. 10-2014-0124532 filed on Sep. 18, 2014, the subject matter of which is hereby incorporated by reference.

### BACKGROUND

Embodiments of the inventive concept relate generally to data recovery techniques. More particularly, embodiments of the inventive concept relate to methods of operating a RAID system and/or a constituent data storage device generating a write command log in response to a log start command and communicating the write command log to a RAID controller.

A Redundant Array of Independent Disks (RAID) may be used to prevent data loss when one or more of the data storage devices fail. RAID system include, for example, mirror RAID and parity RAID systems, wherein the same data stored in a memory region corresponding to a first logical block address (LBA) of a first data storage device is also stored in a memory region corresponding to a first LBA of a second data storage device.

It is assumed that after second data was successfully stored in the memory region corresponding to the first LBA of the first data storage device, the second data has not been successfully stored in the memory region corresponding to the first LBA of the second data storage device because of a sudden power off (SPO) event. When a system including the first data storage device and the second data storage device is rebooted following the SPO event, data stored in the first data storage device may be inconsistent with data stored in the second data storage device.

As a result, the RAID controller should perform task(s) necessary to maintaining consistency of the data stored between the first data storage device and second data storage device. However, since the RAID controller is usually not capable of identifying an LBA at which inconsistent data is stored, it needs to perform comparison on all data stored in both data storage devices. When two data sets compared with each other are not the same as each other, the RAID controller copies a data set stored in one of two data storage devices to the other data storage device in order to maintain data consistency.

It may take a great deal of time to compare all data stored in two data storage devices and then copy relevant data in order to maintain data consistency. Moreover, it is often hard to identify which if the two data storage devices stores latest data. For instance, it is difficult for the RAID controller to decide whether to copy data stored in the first data storage device to the second data storage device or data stored in the second data storage device to the first data storage device.

### SUMMARY

Some embodiments of the inventive concept provide a method of operating a data storage device for generating a log for write commands output from a controller in response to a log start command from the controller and communicating the log to the controller, thereby quickly recovering data when a system is rebooted after a sudden power off (SPO) event, and a method of operating a redundant array of independent disks (RAID) system including the data storage device.

According to some embodiments of the inventive concept, there is provided a method of operating a data storage device. The method includes receiving a log start command from a controller, generating a log for write commands communicated from the controller in response to the log start command, storing the log in a memory, receiving a log read command from the controller, and communicating the log stored in the memory to the controller in response to the log read command. The data storage device may be either a hard disk drive (HDD) or a solid state drive (SSD).

The generating the log may include parsing each of the write commands; and generating the log including a logical block address and a sector counter, which are included in each of the write commands that have been parsed. The memory may be either a volatile memory or a non-volatile memory.

The storing the log in the memory may include storing the log stored in a volatile memory in the memory using a capacitor included in the data storage device when sudden power off occurs in the data storage device, and the memory is a non-volatile memory. The log read command may be input after the data storage device is rebooted since sudden power off.

According to other embodiments of the inventive concept, there is provided a method of operating a RAID system which includes a controller and a first data storage device. The method includes the first data storage device receiving a first log start command from the controller; the first data storage device generating a first log for first write commands communicated from the controller in response to the first log start command; the first data storage device storing the first log in a first memory; the first data storage device receiving a first log read command from the controller after being rebooted since sudden power off; and the first data storage device communicating the first log stored in the first memory to the controller in response to the first log read command.

The controller may be a software RAID controller executed by a central processing unit (CPU). Alternatively, the controller may be a hardware RAID controller implemented in a RAID controller card.

The RAID system may further include a second data storage device and the controller may communicate the first log start command only to the first data storage device. The method may further include the controller copying data, which has been stored in the first data storage device and is relevant to the first write commands, to the second data storage device based on the first log.

Alternatively, the RAID system may further include the second data storage device; and the method may further include a second data storage device receiving a second log start command from the controller, the second data storage device generating a second log for second write commands communicated from the controller in response to the second log start command, the second data storage device storing the second log in a second memory, the second data storage device receiving a second log read command from the controller after being rebooted since sudden power off, and the second data storage device communicating the second log stored in the second memory to the controller in response to the second log read command.

The method may further include the controller copying data, which has been stored in the first data storage device and is relevant to the first write commands, to the second data storage device based on the first log; and the controller copying data, which has been stored in the second data storage device and is relevant to the second write commands, to the first data storage device based on the second log.

Each of the first and second data storage devices may be an HDD or an SSD. Alternatively, the first data storage device may be one of an HDD and an SSD and the second data storage device may be the other one of the HDD and the SSD.

The method may further include the controller generating the first log start command and the second log start command at different times.

The method may further include the controller generating each of the first write commands and each of the second write commands at different times.

The RAID system may be either a mirroring RAID system or a parity RAID system.

According to further embodiments of the inventive concept, there is provided a method of operating a RAID system which includes a controller, a first data storage device, and a second data storage device. The method includes the first data storage device generating a first log for first write commands communicated from the controller based on a first log start command communicated from the controller and to store the first log in a first memory; the second data storage device generating a second log for second write commands communicated from the controller based on a second log start command communicated from the controller and to store the second log in a second memory; the first data storage device communicating the first log stored in the first memory to the controller based on a first log read command communicated from the controller after the first data storage device is rebooted since first sudden power off; and the second data storage device communicating the second log stored in the second memory to the controller based on a second log read command communicated from the controller after the second data storage device is rebooted since second sudden power off.

The method may further include the controller copying data, which has been stored in the first data storage device and is relevant to the first write commands, to the second data storage device based on the first log; and the controller copying data, which has been stored in the second data storage device and is relevant to the second write commands, to the first data storage device based on the second log.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a block diagram illustrating a Redundant Array of Independent Disks (RAID) system according to embodiments of the inventive concept;

FIG. 2 is a block diagram further illustrating in one example the RAID system of FIG. 1;

FIGS. 3 and 4 are respective diagrams illustrating operations of the RAID system of FIG. 2 according to embodiments of the inventive concept;

FIGS. 5A and 5B are diagrams illustrating write command logs according to embodiments of the inventive concept;

FIGS. 6, 7 and 8 are respective diagrams illustrating operations of the RAID system of FIG. 2 according to embodiments of the inventive concept;

FIG. 9 is a block diagram illustrating a RAID system according to other embodiments of the inventive concept;

FIGS. 10 and 11 are respective diagrams illustrating operations of the RAID system of FIG. 9 according to embodiments of the inventive concept;

FIGS. 12, 13, 14 and 15 are respective flowcharts summarizing various methods of operating a RAID system and/or constituent data storage device according to embodiments of the inventive concept; and

FIG. 16 is a block diagram illustrating a data processing system including the RAID system consistent with an embodiment of the inventive concept.

### DETAILED DESCRIPTION

Embodiments of the inventive concept will now be described in some additional detail with reference to the accompanying drawings. This inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference numbers and labels are used to denote like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

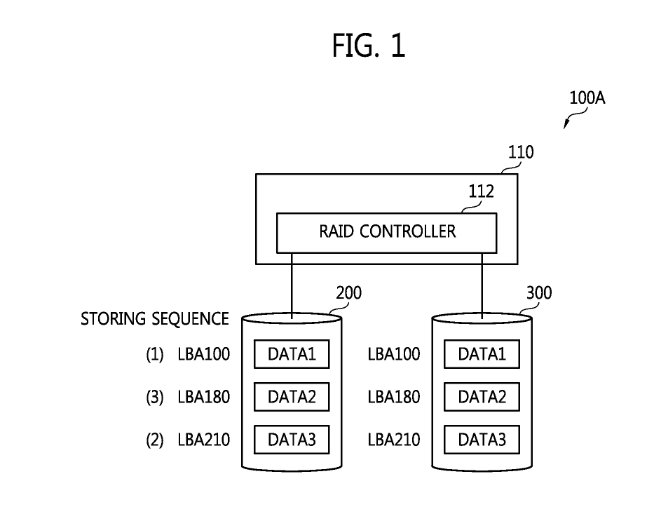

Figure (FIG.) 1 is a block diagram illustrating a Redundant Array of Independent Disks (RAID) system 100A according to certain embodiments of the inventive concept. Referring to FIG. 1, the RAID system 100A generally comprises a control unit 110 and data storage devices 200 and 300.

The control unit 110 may be implemented as a RAID controller card. In this case, a RAID controller 112 within the control unit 110 may be implemented as a hardware RAID controller. The control unit 110 communicates with a host (not shown in FIG. 1) that controls the operation of the RAID system 100A. Alternatively, the control unit 110 may be implemented as a central processing unit (CPU). In context, the constituent CPU may take many different forms, such as a processor or processing core. Hence, the RAID controller 112 within the control unit 110 may be implemented as a software RAID controller capable of execution by the CPU.

Whether the control unit 110 is implemented with a hardware RAID controller, software RAID controller, or some combination of hardware/software RAID controller, it may be used to control the individual and collective operation of the data storage devices 200 and 300. For example, the RAID controller 112 may communicate commands and/or data with the data storage devices 200 and 300 using one or more conventionally understood protocols such as serial advanced technology attachment (SATA) or peripheral component interconnect express (PCIe). Although, only two data storage devices 200 and 300 are illustrated in FIG. 1 those skilled in the art will understand that more than two data storage devices may be used in various embodiments of the inventive concept.

Each of the data storage devices 200 and 300 may be respectively implemented as a hard disk drive (HDD), a solid state drive (SSD), or similar bulk data storage device. For example, one of the data storage devices 200 and 300 may be implemented as an HDD and the other may be implemented as an SSD. Thus, in certain embodiments of the inventive concept, the RAID system 100A may be a hybrid RAID system.

Referring to FIG. 1, the RAID system 100A may be implemented as a mirror RAID system. For example, the RAID system 100A may be implemented as RAID 0 or RAID 10, where first data DATA1 is stored in a memory region corresponding to a logical block address (LBA) 100 of each of the data storage devices 200 and 300, third data DATA3 is stored in a memory region corresponding to a logical block address LBA210 of each of the data storage devices 200 and 300, and second data DATA2 is stored in a memory region corresponding to a logical block address LBA180 of each of the data storage devices 200 and 300. Thus, the illustrated example of FIG. 1 assumes that the RAID controller 112 provides logical block addresses in an order of LBA100, LBA210, and LBA180.

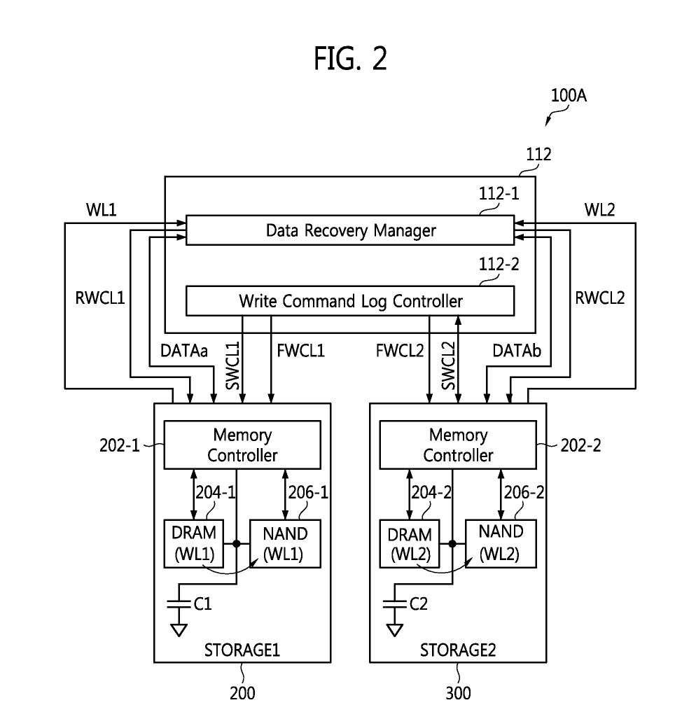

FIG. 2 is a block diagram further illustrating in one example the RAID system 100A of FIG. 1. Referring to FIG. 2, the RAID controller 112 includes a data recovery manager 112-1 and a write command log controller 112-2, where each of these components 112-1 and 112-2 may be implemented in hardware, software or a combination of hardware/software.

The data recovery manager 112-1 functions as a data recovery controller (or a data recovery module). During a reboot, the data recovery manager 112-1 may be used to perform data recovery using data stored in the data storage devices 200 and 300, and with reference to write command logs WL1 and WL2, respectively provided by the data storage devices 200 and 300.

For example, the data recovery manager 112-1 may provide respective log read commands RWCL1 and RWCL2 to the data storage devices 200 and 300 in order to receive the respective write command logs WL1 and WL2 from the data storage devices 200 and 300. Then, the data recovery manager 112-1 may copy data from the first data storage device 200 to second data storage device 300, or from the second data storage device 300 to the first data storage device 200 using the write command logs WL1 and WL2.

In this manner, data consistency between the first and second data storage devices 200 and 300 may be maintained. Respective data (DATAa) and (DATAb) illustrated in FIG. 2 is data transferred between the first and second data storage devices 200 and 300 under the control of the data recovery manager 112-1, and is used to maintain data consistency between the first and second data storage devices 200 and 300.

The data recovery manager 112-1 may also be used to output write commands and read commands to the data storage devices 200 and 300, and therefore, to control the respective output timing for the write commands and read commands. Alternatively, the write command log controller 112-2 may be used to provide write commands and read commands to the data storage devices 200 and 300, and therefore, to control the respective output timing for the write commands and read commands.

The data recovery manager 112-1 may also control the respective output timing for the log read commands RWCL1 and RWCL2. Various design modifications may be made to the illustrated example of FIG. 2 such that some of the functionality described for the data recovery manager 112-1 is performed by the write command log controller 112-2, and some of the functionality for the write command log controller 112-2 is performed by the data recovery manager 112-1.

However, in FIG. 2, the write command log controller 112-2 is assumed to communicate respective log start commands SWCL1 and SWCL2 and respective log finish commands FWCL1 and FWCL2 to the data storage devices 200 and 300. In this manner, the write command log controller 112-2 may control the output timings of the log start commands SWCL1 and SWCL2 and/or the output timings of the log finish commands FWCL1 and FWCL2.

The first data storage device 200 of FIG. 2 includes a first memory controller 202-1, a first volatile memory 204-1, a first non-volatile memory 206-1, and a first capacitor C1. The first memory controller 202-1 may be used to control the communication of commands and/or data between the RAID controller 112 and the first data storage device 200.

The first memory controller 202-1 may be used to generate the first write command log WL1 for first write commands output from the RAID controller 112 in response to the first log start command SWCL1 output from the RAID controller 112, and store the first write command log WL1 in the first volatile memory 204-1. Here, the first volatile memory 204-1 may be a dynamic random access memory (DRAM) and/or a static random access memory (SRAM). For example, the first memory controller 202-1 may parse first write commands and generate the first write command log WL1 including a logical block address and a sector count which are included in each of the parsed first write commands.

When a sudden power off (SPO) event occurs in the first data storage device 200, the first memory controller 202-1 may store the first write command log WL1 stored in the first volatile memory 204-1 into the first non-volatile memory 206-1 during a period in which power (e.g., in the form of at least a minimal operating voltage) is retained in the first capacitor C1. In this regard, the first non-volatile memory 206-1 may be a flash-based memory, such as a NAND flash memory and/or a NOR flash memory in certain embodiments of the inventive concept.

The first memory controller 202-1 may halt generation of the first write command log WL1 and/or delete the first write command log WL1 from the first volatile memory 204-1 in response to the first log finish command FWCL1 provided by the RAID controller 112. After the RAID system 100A or the first data storage device 200 is rebooted following a SPO event, the first memory controller 202-1 may be used to read the first write command log WL1 from the first non-volatile memory 206-1 and communicate the first write command log WL1 to the RAID controller 112 in response to the first log read command RWCL1 provided by the RAID controller 112.

The first memory controller 202-1 may write data corresponding to each of first write commands output from the RAID controller 112 to the first non-volatile memory 206-1. The first memory controller 202-1 may also read data from the first non-volatile memory 206-1 according to each of first read commands output from the RAID controller 112 and output the data to the RAID controller 112.

The second data storage device 300 of FIG. 2 includes a second memory controller 202-2, a second volatile memory 204-2, a second non-volatile memory 206-2, and a second capacitor C2. The second memory controller 202-2 may be used to control the communication of commands and/or data between the RAID controller 112 and the second data storage device 300.

The second memory controller 202-2 may be used to generate the second write command log WL2 for second write commands output from the RAID controller 112 in response to the second log start command SWCL2 provided by the RAID controller 112 and store the second write command log WL2 in the second volatile memory 204-2. Here again, the second volatile memory 204-2 may be a DRAM and/or a SRAM. For convenience of description, the write command(s) received by the first data storage device 200 will be referred to as “first write command(s)”, while write command(s) received by the second data storage device 300 will be referred to as “second write command(s)”.

The second memory controller 202-2 may be used to parse second write commands and generate the second write command log WL2 including a logical block address and a sector count which are included in each of the parsed second write commands.

When a SPO event occurs in the second data storage device 300, the second memory controller 202-2 may be used to store the second write command log WL2 stored in the second volatile memory 204-2 into the second non-volatile memory 206-2 during a period in which power (e.g., in the form of at least a minimal operating voltage) is retained in the second capacitor C2. Like the first non-volatile memory 206-1, the second non-volatile memory 206-2 may be a flash-based memory.

Each of the first non-volatile memory 206-1 and second non-volatile memory 206-2 may include a two dimensional (2D) memory array and/or a three dimensional (3D) memory array. The 3D memory array may be monolithically formed in one or more physical levels of arrays of memory cells having an active area disposed above a silicon substrate and circuitry associated with the operation of those memory cells, whether such associated circuitry is above or within such substrate. In this context, the term “monolithic” means that layers of each level of the array are directly deposited on the layers of each underlying level of the array. In certain embodiments of the inventive concept, the 3D memory array may include vertical NAND strings oriented such that at least one memory cell is located over another memory cell, where the at least one memory cell includes a charge trap layer. Examples of 3D memory arrays that may be suitable for incorporation within one or more embodiments of the inventive concept may be found in U.S. Pat. Nos. 7,679,133; 8,553,466; 8,654,587; and 8,559,235, as well as published U.S. Patent Application 2011/0233648, the collective subject matter of which is hereby incorporated by reference.

The second memory controller 202-2 may halt generation of the second write command log WL2 and/or delete the second write command log WL2 from the second volatile memory 204-2 in response to the second log finish command FWCL2 provided by the RAID controller 112. After the RAID system 100A or the second data storage device 300 reboots following a SPO event, the second memory controller 202-2 may read the second write command log WL2 from the second non-volatile memory 206-2 and communicate the second write command log WL2 to the RAID controller 112 in response to the second log read command RWCL2 provided by the RAID controller 112.

The second memory controller 202-2 may be used to write data corresponding to each of second write commands received from the RAID controller 112 to the second non-volatile memory 206-2. The second memory controller 202-2 may also read data from the second non-volatile memory 206-2 according to each of second read commands received from the RAID controller 112, and accordingly output the data to the RAID controller 112.

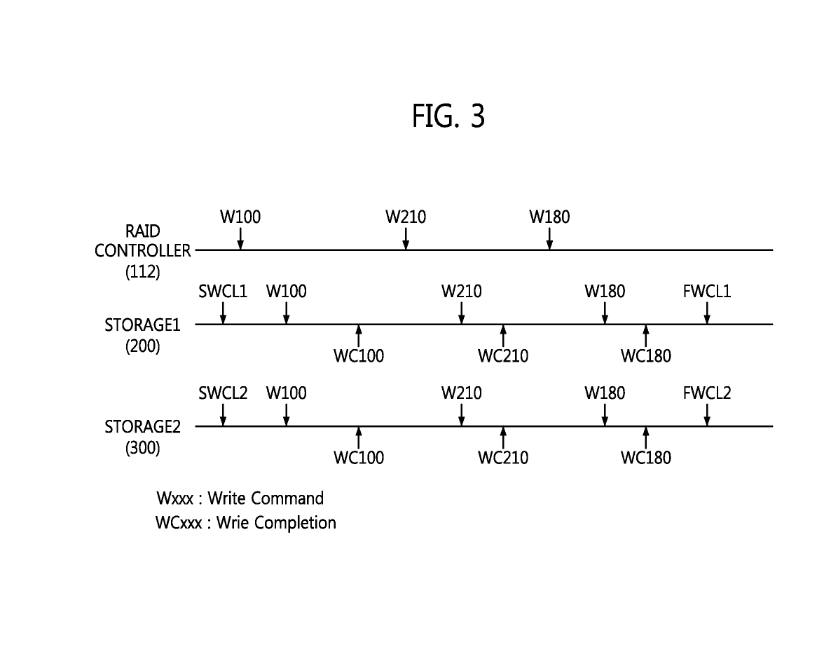

FIG. 3 is a conceptual diagram illustrating various operations executed by the RAID system 100A of FIG. 2 according to embodiments of the inventive concept. Referring to FIGS. 1, 2 and 3, the data storage devices 200 and 300 receive respective log start commands SWCL1 and SWCL2 from the RAID controller 112 and start generation of the write command logs WL1 and WL2. Each of the write command logs WL1 and WL2 is for write commands received by a corresponding one of the data storage devices 200 and 300 starting from the moment when a corresponding one of the log start commands SWCL1 and SWCL2 is received.

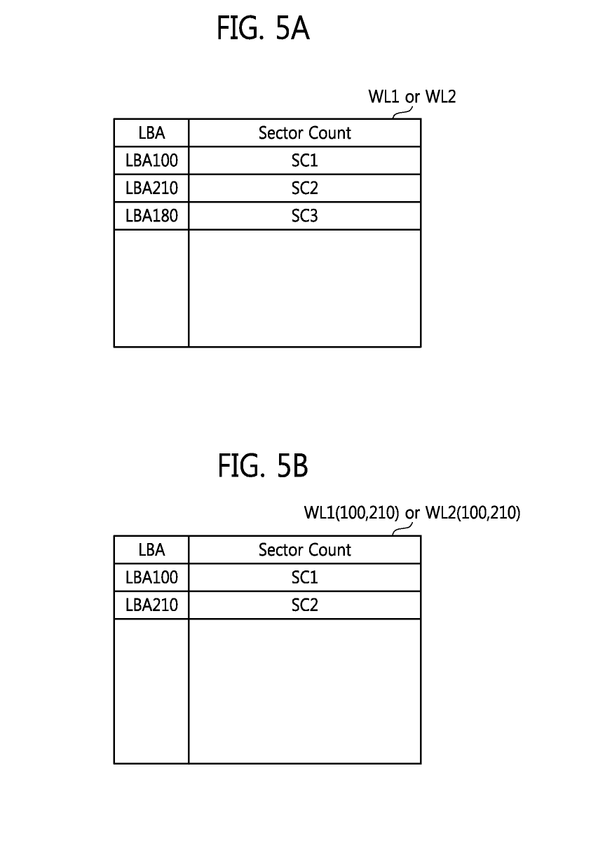

The first data storage device 200 receives the first log start command SWCL1 and generates the first write command log WL1 for first write commands W100, W210, and W180 which are sequentially communicated from the RAID controller 112 in response to the first log start command SWCL1. The second data storage device 300 receives the second log start command SWCL2 and generates the second write command log WL2 for second write commands W100, W210, and W180 which are sequentially communicated from the RAID controller 112 in response to the second log start command SWCL2. One example of the first write command log WL1 and/or the second write command log WL2 is illustrated in FIG. 5A.

Each of the write commands W100, W210, and W180 may include a logical block address (LBA), a sector count, and write data. The sector count is relevant to the size of a sector or the number of sectors.

FIGS. 5A and 5B are respective diagrams conceptually illustrating the write command logs WL1 and WL2 for write commands according to embodiments of the inventive concept. Here, each of the data storage devices 200 and 300 is assumed to write first write data included in the write command W100 (or related to the write command W100) to the non-volatile memory 206-1 or 206-2 (e.g., a first memory region in NAND flash memory) based on a first LBA LBA100 and a first sector count SC1 included in the write command W100.

After the write operation is completed, each of the data storage devices 200 and 300 communicates a write completion signal WC100 to the RAID controller 112. For example, the write completion signal WC100 may be communicated to the write command log controller 112-2. At this time, the data storage devices 200 and 300 may parse the write command W100 and generate the write command logs WL1 and WL2, respectively, including the first LBA LBA100 and the first sector count SC1 generated as a result of the parsing.

Thereafter, each of the data storage devices 200 and 300 may write second write data included in the write command W210 (or related to the write command W210) to the non-volatile memory 206-1 or 206-2 (e.g., a second memory region in NAND flash memory) based on a second LBA LBA210 and a second sector count SC2 included in the write command W210.

After the write operation is completed, each of the data storage devices 200 and 300 communicates a write completion signal WC210 to the RAID controller 112. For example, the write completion signal WC210 may be communicated to the write command log controller 112-2. At this time, the data storage devices 200 and 300 may parse the write command W210 and generate or update the write command logs WL1 and WL2, respectively, including the second LBA LBA210 and the second sector count SC2 generated as a result of the parsing.

Thereafter, each of the data storage devices 200 and 300 may write third write data included in the write command W180 (or related to the write command W180) to the non-volatile memory 206-1 or 206-2 (e.g., a second memory region in NAND flash memory) based on a third LBA LBA180 and a third sector count SC3 included in the write command W180.

After the write operation is completed, each of the data storage devices 200 and 300 communicates a write completion signal WC180 to the RAID controller 112. For instance, the write completion signal WC180 may be communicated to the write command log controller 112-2. At this time, the data storage devices 200 and 300 may parse the write command W180 and generate or update the write command logs WL1 and WL2, respectively, including the third LBA LBA180 and the third sector count SC3 generated as a result of the parsing.

Thus, as shown in FIG. 5A, the write command logs WL1 and WL2 for the write commands W100, W210, and W180 include LBAs LBA100, LBA210, and LBA180 and the sector counts SC1, SC2, and SC3. The write command logs WL1 and WL2 for the write commands W100, W210, and W180 are respectively stored in the volatile memories 204-1 and 204-2 according to the memory controllers 202-1 and 202-2, respectively.

The RAID controller 112 outputs the log finish commands FWCL1 and FWCL2 to the data storage devices 200 and 300, respectively, based on the write completion signal WC180 output from the data storage devices 200 and 300. Accordingly, the data storage devices 200 and 300 may delete the write command logs WL1 and WL2 from the volatile memories 204-1 and 204-2 in response to the log finish commands FWCL1 and FWCL2, respectively. As a result, an efficient allocation of memory space in the volatile memories 204-1 and 204-2 may obtained.

When a SPO event does not occur in the RAID system 100A until the execution of write operations for all write data included in (or related to) the write commands W100, W210, and W180 is completed, the RAID controller 112 will provide log finish commands FWCL1 and FWCL2 to the data storage devices 200 and 300, respectively.

The first data storage device 200 generates the first write command log WL1 for the first write commands W100, W210, and W180 output from the RAID controller 112 without receiving any special command(s) being communicated to/from the RAID controller 112. Thus the number of commands necessarily exchanged between the first data storage device 200 and the RAID controller 112 may be reduced.

In addition, the second data storage device 300 generates the second write command log WL2 for the second write commands W100, W210, and W180 provided by the RAID controller 112, again without exchanging any special command(s) to/from the RAID controller 112.

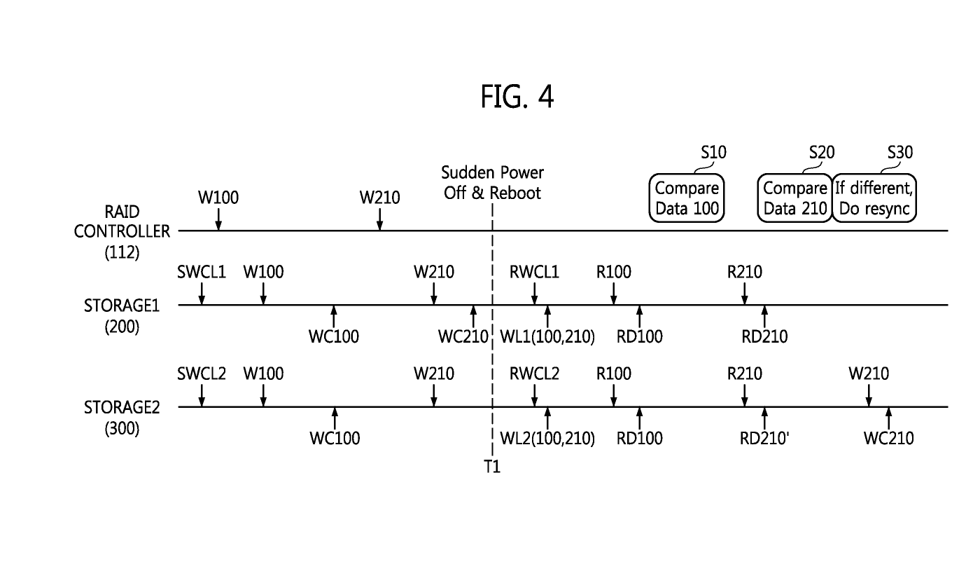

FIG. 4 is another conceptual diagram illustrating the execution of various operations by the RAID system 100A of FIG. 2 according to embodiments of the inventive concept. The example illustrated in FIG. 4 highlights a method of efficiently recovering data when the RAID system 100A or the data storage device 200 or 300 is rebooted due to a SPO event.

In FIG. 4, it is assumed that a SPO event occurs in relation to the RAID system 100A or the data storage device 200 or 300 at a time T1.

Referring to FIGS. 1, 2 and 4 and comparing the example of FIG. 3, while a write operation corresponding to the write command W210 has been successfully executed in the first data storage device 200, it fails in the second data storage device 300 dues to the SPO event. That is, before the SPO event occurs in the RAID system 100A, the first data storage device 200 has output the write completion signal WC210 to the RAID controller 112, but the second data storage device 300 has yet to output the write completion signal WC210 to the RAID controller 112.

Nonetheless, the first write command log WL1 generated by the first memory controller 202-1 for the write commands W100 and W210 is copied from the first volatile memory 204-1 to the first non-volatile memory 206-1 at time T1 using a residual operating voltage provided (e.g.,) by the charge stored in the first capacitor C1. In addition, the second write command log WL2 generated by the second memory controller 202-2 for the write commands W100 and W210 is copied from the second volatile memory 204-2 to the second non-volatile memory 206-2 at time T1 using a residual operating voltage provided (e.g.,) by the charge stored in the second capacitor C2.

After the RAID system 100A is rebooted following the SPO event, the RAID controller 112 communicates the log read commands RWCL1 and RWCL2 to the memory controllers 202-1 and 202-2, respectively. The memory controllers 202-1 and 202-2 respectively communicate write command logs WL1(100, 210) and WL2(100,210) stored in the non-volatile memories 206-1 and 206-2 to the RAID controller 112. The write command logs WL1(100, 210) and WL2(100,210) include the LBAs LBA100 and LBA210 and the sector counters SC1 and SC2, as shown in FIG. 5B.

The RAID controller 112 (i.e., the data recovery manager 112-1) may be used to determine whether the write commands W100 and W210 have been communicated to the first data storage device 200 before the SPO event occurs based on the first write command log WL1(100, 210) and also based on the second write command log WL2(100, 210).

The data recovery manager 112-1 of the RAID controller 112 may be used to provide a read command R100 to each of the data storage devices 200 and 300, where the memory controllers 202-1 and 202-2 of the respective data storage devices 200 and 300 output data RD100 stored in their respective memory regions corresponding to the LBA100 to the data recovery manager 112-1 in response to the read command R100. The data recovery manager 112-1 may also be used to compare the data RD100 output from the first data storage device 200 with the data RD100 output from the second data storage device 300 (operation S10) in order to determine whether these two sets of data RD100 are the same.

Then, the data recovery manager 112-1 of the RAID controller 112 may be used to output another read command R210 to each of the data storage devices 200 and 300, where the memory controllers 202-1 and 202-2 of the respective data storage devices 200 and 300 output data RD210 and RD210′ stored in their respective memory regions corresponding to the LBA LBA100 to the data recovery manager 112-1 in response to the another read command R210. The data recovery manager 112-1 may also be used to compare the data RD210 output from the first data storage device 200 with the data RD210′ output from the second data storage device 300 (operation S20) in order to determine whether these two sets of data RD210 are the same.

Thereafter, the data recovery manager 112-1 may be used to execute a resynchronization operation correlating the data RD210 from the first data storage device 200 with the data RD210′ from the second data storage device 300 (operation S30), if necessary. Hence, the data RD210 will be considered the latest data.

Then, the data recovery manager 112-1 may be used to output commands for copying the data RD210 (i.e., the latest data stored in the first data storage device 200) to the second data storage device 300. For example, the first memory controller 202-1 reads the data RD210 from the memory region corresponding to the LBA LBA210 in the first non-volatile memory 206-1 in response to the read command R210 output from the data recovery manager 112-1 and outputs the data RD210 to the data recovery manager 112-1. The data recovery manager 112-1 communicates the write command W210 to the second memory controller 202-2. The second memory controller 202-2 writes the data RD210 output from the first memory controller 202-1 to the memory region corresponding to the LBA LBA210 in the second non-volatile memory 206-2 in response to the write command W210. When the write operation is completed, the second memory controller 202-2 provides the write completion signal WC210 to the write command log controller 112-2.

The memory controllers 202-1 and 202-2 may be used to generate a sequence number for each write command when generating the write command logs WL1 and WL2, respectively. For instance, the memory controllers 202-1 and 202-2 may assign sequence number 1 to LBA100 and sequence number 2 to LBA210. Accordingly, when resynchronization is performed, the data recovery manager 112-1 may compare two data sets corresponding to LBA100 first according to sequence numbers and then compare two data sets corresponding to LBA210. Sequence numbers may be assigned or determined according to the order of write commands communicated to the data storage devices 200 and 300. Alternatively, the memory controllers 202-1 and 202-2 may generate a time stamp for each write command when generating the write command logs WL1 and WL2, respectively, where the time stamp represents (e.g.,) date, hours, minutes and seconds.

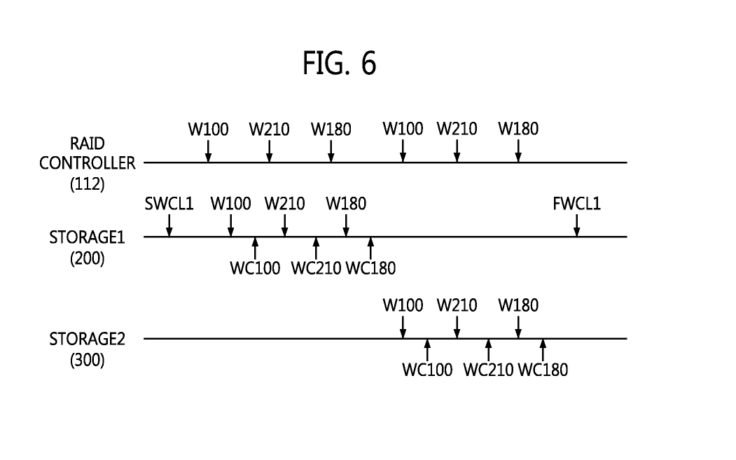

FIG. 6 is another conceptual diagram illustrating operation of the RAID system 100A of FIG. 2 according to embodiments of the inventive concept. As shown in FIG. 3, the RAID controller 112 communicates a pair of the first and second write commands W100, W210, or W180 to both of the data storage devices 200 and 300. That is, the first write command W100 may be simultaneously communicated to both of the data storage devices 200 and 300. However, the data recovery manager 112-1 may communicate the first write commands W100, W210, and W180 to the first data storage device 200 and the second write commands W100, W210, and W180 to the second data storage device 300 at different times.

As shown in FIG. 6, the RAID controller 112 outputs the first log start command SWCL1 to the first data storage device 200 only and sequentially outputs the first write commands W100, W210, and W180 to the first data storage device 200. The first memory controller 202-1 generates the first write command log WL1 for the first write commands W100, W210, and W180 received since the time when the first log start command SWCL1 is received. The first memory controller 202-1 may generate the first write command log WL1 every time when each of the first write commands W100, W210, and W180 is received. The number of LBAs (or entries) included in the first write command log WL1 may be the same as the number of first write commands. Here, an entry may include an LBA and a sector count.

After communicating the first write commands W100, W210, and W180 to the first memory controller 202-1, the RAID controller 112 communicates the second write commands W100, W210, and W180 to the second memory controller 202-2.

When the write operation for each of the first write commands W100, W210, and W180 is completed in the first data storage device 200, the first memory controller 202-1 outputs a corresponding one of the write completion signals WC100, WC210, and WC180 to the RAID controller 112, e.g., the write command log controller 112-2. Also, when the write operation for each of the second write commands W100, W210, and W180 is completed in the second data storage device 300, the second memory controller 202-2 outputs a corresponding one of the write completion signals WC100, WC210, and WC180 to the RAID controller 112, e.g., the write command log controller 112-2.

The write command log controller 112-2 outputs the first log finish command FWCL1 to the first memory controller 202-1 in response to the write completion signal WC180 (i.e., the last write completion signal output from the second memory controller 202-2). The first memory controller 202-1 halts generation of the first write command log WL1 in response to the first log finish command FWCL1 and deletes the first write command log WL1 from the first volatile memory 204-1.

If the RAID controller 112 outputs a log start command and a log finish command to only one of the data storage devices 200 and 300, the RAID controller 112 clearly identify which of the data storage devices 200 and 300 the last data has been stored in when data is recovered after a reboot. Thus, when the RAID controller 112 outputs a log start command and write commands to one of the data storage devices 200 and 300 first, the RAID controller 112 can ensure that data stored in the one of the data storage devices 200 and 300 is the latest data. Therefore, when the RAID system 100A is rebooted following a SPO event, the RAID controller 112 is able to determine that data stored in the one of the data storage devices 200 and 300 is the latest data using a write command log associated with at least one of the data storage devices 200 and 300.

Memory space for write command logs is saved when a write command log is stored in only one of the data storage devices 200 and 300 as compared to when a write command log is stored in each of the data storage devices 200 and 300.

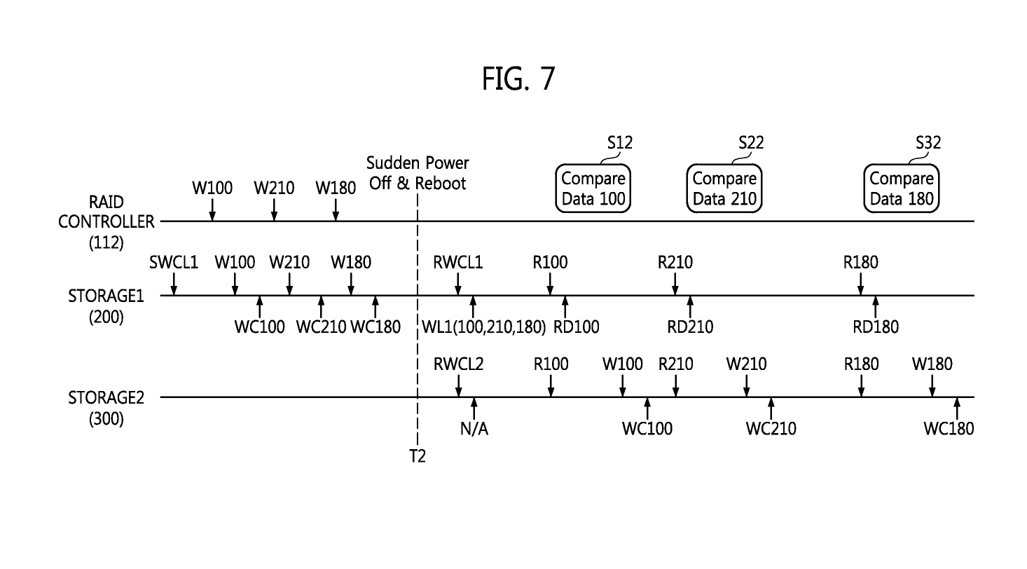

FIG. 7 is a diagram conceptually illustrating operation of the RAID system 100A of in FIG. 2 according to embodiments of the inventive concept. Referring to FIGS. 6 and 7, it is assumed that a SPO event has occurred for the RAID system 100A or the data storage device 200 or 300 at time T2.

The RAID controller 112 outputs the first log start command SWCL1 and the first write commands W100, W210, and W180 only to the first data storage device 200 among the data storage devices 200 and 300. The first memory controller 202-1 generates the first write command log WL1 for the first write commands W100, W210, and W180 and stores the first write command log WL1 in the first volatile memory 204-1. Before the SPO event occurs, the first memory controller 202-1 outputs the write completion signals WC100, WC210, and WC180 to the RAID controller 112. When SPO occurs, the first memory controller 202-1 stores the first write command log WL1 stored in the first volatile memory 204-1 in the first non-volatile memory 206-1 using a residual operating voltage derived from charge stored in the first capacitor C1.

After the RAID system 100A is rebooted following the SPO event, the data recovery manager 112-1 outputs the first log read command RWCL1 to the first memory controller 202-1 and outputs the second log read command RWCL2 to the second memory controller 202-2. The log read commands RWCL1 and RWCL2 may be output to the data storage devices 200 and 300 at the same time or at different times.

The first memory controller 202-1 reads a first write command log WL1(100, 210, 180) from the first non-volatile memory 206-1 in response to the first log read command RWCL1 and communicates the first write command log WL1(100, 210, 180) to the data recovery manager 112-1. The first write command log WL1(100, 210, 180) includes a sector count per LBA, as shown in FIG. 5A. However, since a write command log does not exist in the second data storage device 300, the second memory controller 202-2 does not communicate the write command log to the data recovery manager 112-1 in response to the second log read command RWCL2.

The data recovery manager 112-1 outputs the read command R100 to the memory controllers 202-1 and 202-2 using the first write command log WL1(100, 210, 180). The first memory controller 202-1 reads the data RD100 corresponding to the read command R100 from the first non-volatile memory 206-1 and communicates the data RD100 to the data recovery manager 112-1. However, since data corresponding to the read command R100 does not exist in the second data storage device 300, the second memory controller 202-2 does not communicate the data corresponding to the read command R100 to the data recovery manager 112-1.

The data recovery manager 112-1 compares the data corresponding to the read command R100 between the data storage devices 200 and 300 (operation S12). Since the data corresponding to read command R100 in the in the first data storage device 200 does not coincide with that in the second data storage device 300, data stored in the memory region corresponding to LBA100 in the first data storage device 200 is written to the memory region corresponding to LBA100 in the second data storage device 300 according to the control of the data recovery manager 112-1 using the commands W100 and WC100.

The data recovery manager 112-1 outputs the read command R210 to the memory controllers 202-1 and 202-2 using the first write command log WL1(100, 210, 180). The first memory controller 202-1 reads the data RD210 corresponding to the read command R210 from the first non-volatile memory 206-1 and communicates the data RD210 to the data recovery manager 112-1. However, since data corresponding to the read command R210 does not exist in the second data storage device 300, the second memory controller 202-2 does not communicate the data corresponding to the read command R210 to the data recovery manager 112-1.

The data recovery manager 112-1 compares the data corresponding to the read command R210 between the data storage devices 200 and 300 (operation S22). Since the data corresponding to read command R210 in the in the first data storage device 200 does not coincide with that in the second data storage device 300, data stored in the memory region corresponding to LBA210 in the first data storage device 200 is written to the memory region corresponding to LBA210 in the second data storage device 300 according to the control of the data recovery manager 112-1 using the commands W210 and WC210.

Then, the data recovery manager 112-1 outputs the read command R180 to the memory controllers 202-1 and 202-2 using the first write command log WL1(100, 210, 180). The first memory controller 202-1 reads the data RD180 corresponding to the read command R180 from the first non-volatile memory 206-1 and communicates the data RD180 to the data recovery manager 112-1. However, since data corresponding to the read command R180 does not exist in the second data storage device 300, the second memory controller 202-2 does not communicate the data corresponding to the read command R180 to the data recovery manager 112-1.

The data recovery manager 112-1 compares the data corresponding to the read command R180 between the data storage devices 200 and 300 (operation S32). Since the data corresponding to read command R180 in the in the first data storage device 200 does not coincide with that in the second data storage device 300, data stored in the memory region corresponding to LBA180 in the first data storage device 200 is written to the memory region corresponding to LBA180 in the second data storage device 300 according to the control of the data recovery manager 112-1 using the commands W180 and WC180.

Consequently, the write data RD100, RD210, and RD180 respectively corresponding to the first write commands W100, W210, and W180 are written only to the first data storage device 200 among the data storage devices 200 and 300.

The RAID controller 112 can determine that the data RD100, RD210, and RD180 written to the first data storage device 200 are the latest data based on the first write command log WL1(100, 210, 180). Accordingly, the RAID controller 112 performs resynchronization on the data corresponding to LBA100, LBA210, and LBA180 from the first data storage device 200 to the second data storage device 300. As a result, data consistency between the data storage devices 200 and 300 is maintained.

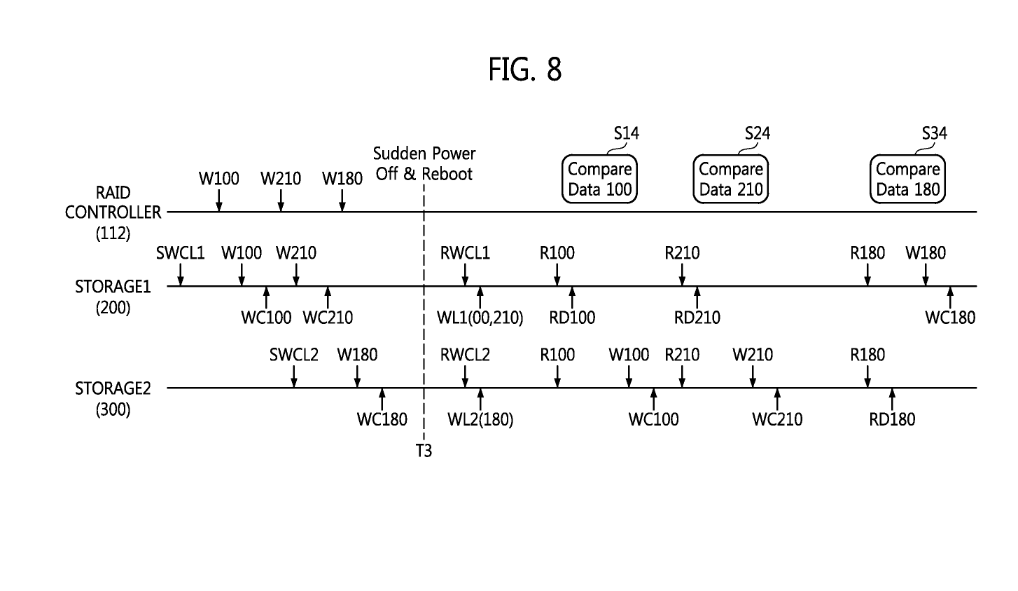

FIG. 8 is a diagram illustrating an operation of the RAID system 100A illustrated in FIG. 2 according to further embodiments of the inventive concept. Referring to FIGS. 2 and 8, the RAID controller 112 outputs the first log start command SWCL1 to the first data storage device 200 and then outputs the second log start command SWCL2 to the second data storage device 300.

The first memory controller 202-1 generates the first write command log WL1 for the first write commands W100 and W210 and stores the first write command log WL1 in the first volatile memory 204-1. The second memory controller 202-2 generates the second write command log WL2 for the second write commands W180 and stores the second write command log WL2 in the second volatile memory 204-2.

When SPO occurs in the RAID system 100A at a third time point T3, the first memory controller 202-1 stores the first write command log WL1 stored in the first volatile memory 204-1 in the first non-volatile memory 206-1 using a voltage charged in the first capacitor C1. In addition, the second memory controller 202-2 stores the second write command log WL2 stored in the second volatile memory 204-2 in the second non-volatile memory 206-2 using a residual operating voltage derived from charge stored in the second capacitor C2.

After the RAID system 100A is rebooted following the SPO event, the data recovery manager 112-1 outputs the first log read command RWCL1 to the first memory controller 202-1 and outputs the second log read command RWCL2 to the second memory controller 202-2.

The first memory controller 202-1 reads a first write command log WL1(100, 210) from the first non-volatile memory 206-1 in response to the first log read command RWCL1 and communicates the first write command log WL1(100, 210) to the data recovery manager 112-1. The second memory controller 202-2 reads a second write command log WL2(180) from the second non-volatile memory 206-1 in response to the second log read command RWCL2 and communicates the second write command log WL2(180) to the data recovery manager 112-1.

The data recovery manager 112-1 outputs the read command R100 to the memory controllers 202-1 and 202-2 based on the first write command log WL1(100, 210). The first memory controller 202-1 reads the data RD100 corresponding to the read command R100 from the first non-volatile memory 206-1 and communicates the data RD100 to the data recovery manager 112-1. However, since data corresponding to the read command R100 does not exist in the second data storage device 300, the second memory controller 202-2 does not communicate the data corresponding to the read command R100 to the data recovery manager 112-1.

The data recovery manager 112-1 compares the data corresponding to the read command R100 between the data storage devices 200 and 300 (operation S14). Since the data corresponding to read command R100 in the in the first data storage device 200 does not coincide with that in the second data storage device 300, data stored in the memory region corresponding to LBA100 in the first data storage device 200 is written to the memory region corresponding to LBA100 in the second data storage device 300 according to the control of the data recovery manager 112-1 using the commands W100 and WC100.

The data recovery manager 112-1 outputs the read command R210 to the memory controllers 202-1 and 202-2 using the first write command log WL1(100, 210). The first memory controller 202-1 reads the data RD210 corresponding to the read command R210 from the first non-volatile memory 206-1 and communicates the data RD210 to the data recovery manager 112-1. However, since data corresponding to the read command R210 does not exist in the second data storage device 300, the second memory controller 202-2 does not communicate the data corresponding to the read command R210 to the data recovery manager 112-1.

The data recovery manager 112-1 compares the data corresponding to the read command R210 between the data storage devices 200 and 300 (operation S24). Since the data corresponding to read command R210 in the in the first data storage device 200 does not coincide with that in the second data storage device 300, data stored in the memory region corresponding to LBA210 in the first data storage device 200 is written to the memory region corresponding to LBA210 in the second data storage device 300 according to the control of the data recovery manager 112-1 using the commands W210 and WC210.

Continuously, the data recovery manager 112-1 outputs the read command R180 to the memory controllers 202-1 and 202-2 based on the second write command log WL2(180). The second memory controller 202-2 reads the data RD180 corresponding to the read command R180 from the second non-volatile memory 206-2 and communicates the data RD180 to the data recovery manager 112-1. However, since data corresponding to the read command R180 does not exist in the first data storage device 200, the first memory controller 202-1 does not communicate the data corresponding to the read command R180 to the data recovery manager 112-1.

The data recovery manager 112-1 compares the data corresponding to the read command R180 between the data storage devices 200 and 300 (operation S34). Since the data corresponding to read command R180 in the in the first data storage device 200 does not coincide with that in the second data storage device 300, data stored in the memory region corresponding to LBA180 in the second data storage device 300 is written to the memory region corresponding to LBA180 in the first data storage device 200 according to the control of the data recovery manager 112-1 using the commands W180 and WC180.

Consequently, the write data RD100 and RD210 respectively corresponding to the first write commands W100 and W210 are written only to the first data storage device 200 among the data storage devices 200 and 300 and the write data RD180 corresponding to the second write command W180 is written only to the second data storage device 300.

The RAID controller 112 can determine that the data RD100 and RD210 written to the first data storage device 200 are the latest data based on the first write command log WL1(100, 210) and that the data RD180 written to the second data storage device 300 is the latest data based on the second write command log WL2(180).

The RAID controller 112 performs resynchronization on the data corresponding to LBA100 and LBA210 from the first data storage device 200 to the second data storage device 300. Also, the RAID controller 112 performs resynchronization on the data corresponding to LBA180 from the second data storage device 300 to the first data storage device 200. As a result, data consistency between the data storage devices 200 and 300 is maintained.

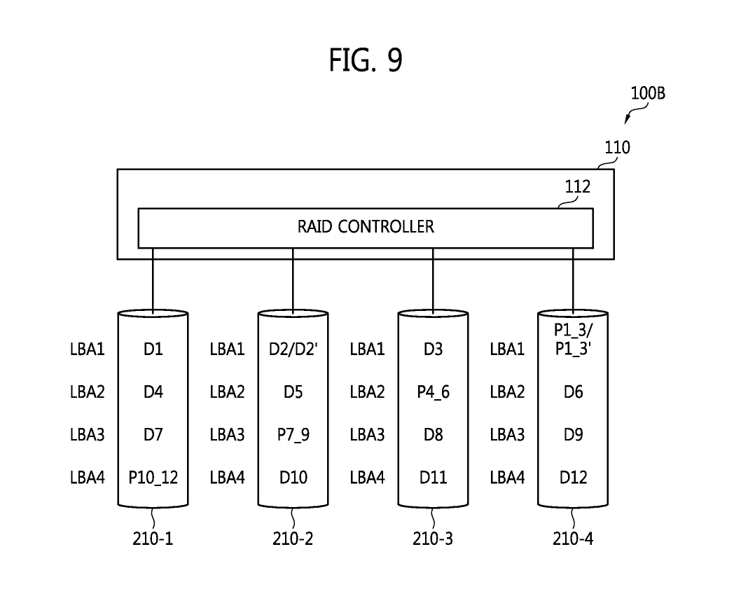

FIG. 9 is a block diagram illustrating a RAID system 100B according to embodiments of the inventive concept. Referring to FIG. 9, the RAID system 100B is assumed to be a parity RAID system (e.g., a RAID 5 system). The RAID system 100B is shown as including the control unit 110 and four data storage devices 210-1 through 210-4.

The structure and operation of the RAID controller 112 included in the control unit 110 of FIG. 9 are substantially similar to those of the RAID controller 112 described in relation to FIG. 2. Further, the structure and operation of the data storage devices 210-1 through 210-4 are substantially similar to those of the data storage device 200 or 300 described in relation to FIG. 2.

However parity data for data corresponding to the same LBA is stored in one of the data storage devices 210-1 through 210-4. For instance, parity data P1_3 for data D1, D2, and D3 each stored in a memory region corresponding to LBA1 is stored in the fourth data storage device 210-4. Parity data P4_6 for data D4, D5, and D6 each stored in a memory region corresponding to LBA2 is stored in the third data storage device 210-3. Parity data P7_9 for data D7, D8, and D9 each stored in a memory region corresponding to LBA3 is stored in the second data storage device 210-2. Parity data P10_12 for data D10, D11, and D12 each stored in a memory region corresponding to LBA4 is stored in the first data storage device 210-1. Parity data P1_3 may be calculated by performing an XOR operation on the data D1, D2, and D3, for example.

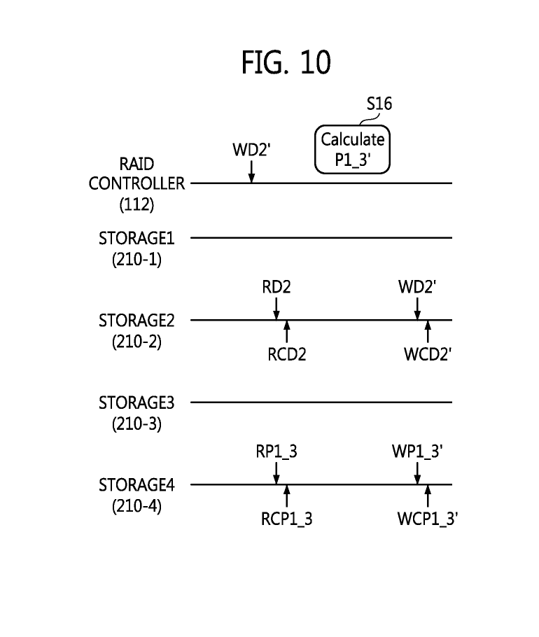

FIG. 10 is a diagram conceptually illustrating operation of the RAID system 100B of FIG. 9 according to embodiments of the inventive concept. When the data D2 is updated with new data D2′, the parity data P1_3 must also be updated with a new parity data P1_3′. The example of FIG. 3 above may be considered to understand a procedure by which the parity data P1_3 is normally updated with the new parity data P1_3′.

Referring now to FIGS. 2, 9, and 10, when an update of the data D2 is required, the RAID controller 112 reads the data D2 from the second data storage device 210-2 using a read command RD2. When the read operation on the data D2 is completed, the second data storage device 210-2 communicates a read completion signal RCD2 to the RAID controller 112. In addition, the RAID controller 112 reads the parity data P1_3 from the fourth data storage device 210-4 using a read command RP1_3. When the read operation on the parity data P1_3 is completed, the fourth data storage device 210-4 communicates a read completion signal RCP1_3 to the RAID controller 112.

The RAID controller 112 performs an XOR operation on the data D2, P1_3, and D2′ in order to calculate the new parity data P1_3′ (operation S16). The RAID controller 112 writes the new data D2′ to the second data storage device 210-2 using a write command WD2′. When the write operation on the new data D2′ is completed, the second data storage device 210-2 communicates a write completion signal WCD2′ to the RAID controller 112. In addition, the RAID controller 112 writes the new parity data P1_3′ to the fourth data storage device 210-4 using a write command WP1_3′. When the write operation on the new parity data P1_3′ is completed, the fourth data storage device 210-4 communicates a write completion signal WCP1_3′ to the RAID controller 112.

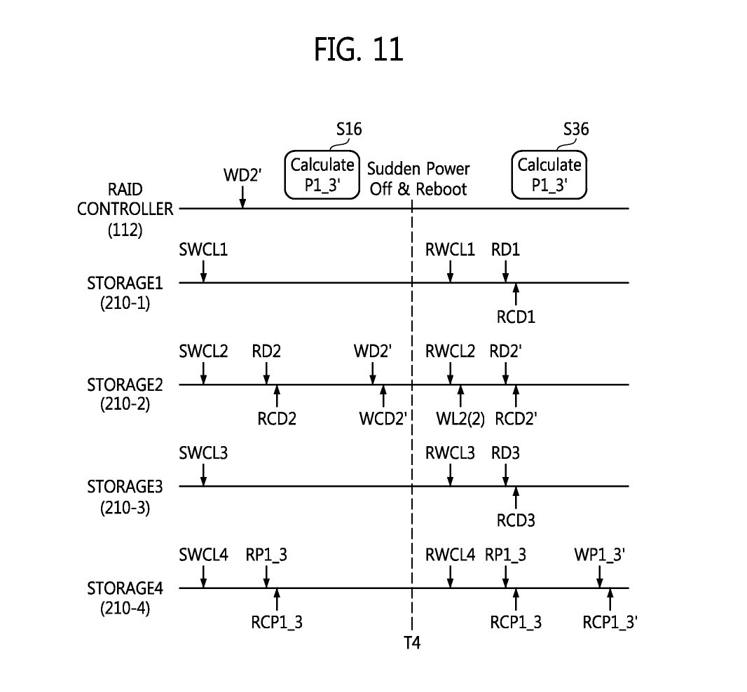

FIG. 11 is a diagram conceptually illustrating operation of the RAID system 100B of FIG. 9 according to embodiments of the inventive concept. Here, however, it is assumed that a SPO event occurs in the RAID system 100B before the new parity data P1_3′ is completely written to the fourth data storage device 210-4 after the new data D2′ is completely written to the second data storage device 210-2.

Referring to FIGS. 9, 10 and 11, the RAID controller 112 outputs log start commands SWCL1 through SWCL4 to the data storage devices 210-1 through 210-4, respectively. The second data storage device 210-2 generates the write command log WL2 for the write command WD2′.

After the second data storage device 210-2 communicates the write completion signal WCD2′ to the RAID controller 112 as described above with reference to FIG. 10, SPO occurs in the RAID system 100B at a time point T4. Since the new parity data P1_3′ has not been written to the fourth data storage device 210-4, a data strip including the data D1 through D3 cannot maintain data consistency.

Hence, when the RAID system 100B is rebooted following the SPO event, the RAID controller 112 outputs log read commands RWCL1 through RWCL4 to the data storage devices 210-1 through 210-4, respectively. Only the second data storage device 210-2 can output the write command log WL2 to the RAID controller 112.

The RAID controller 112 reads the data D1, D2′, D3, and P1_3 from the respective data storage devices 210-1 through 210-4 using read commands RD1, RD2′, RD3, and RP1_3. When the read operation is completed, the data storage devices 210-1 through 210-4 communicate read completion signals RCD1, RCD2′, RCD3, and RCP1_3, respectively, to the RAID controller 112.

The RAID controller 112 performs an XOR operation on the data D1, D2′, and D3 to calculate the parity data P1_3′ (operation S36). The parity data P1_3 output from the fourth data storage device 210-4 is different from the calculated parity data P1_3′, and therefore, the RAID controller 112 writes the new parity data P1_3′ to the fourth data storage device 210-4 using the write command WP1_3′. When the write operation on the new parity data P1_3′ is completed, the fourth data storage device 210-4 communicates the write completion signal WCP1_3′ to the RAID controller 112. As a result, consistency among the data D1, D2′, D3, and P1_3 included in the noted data strip is maintained.

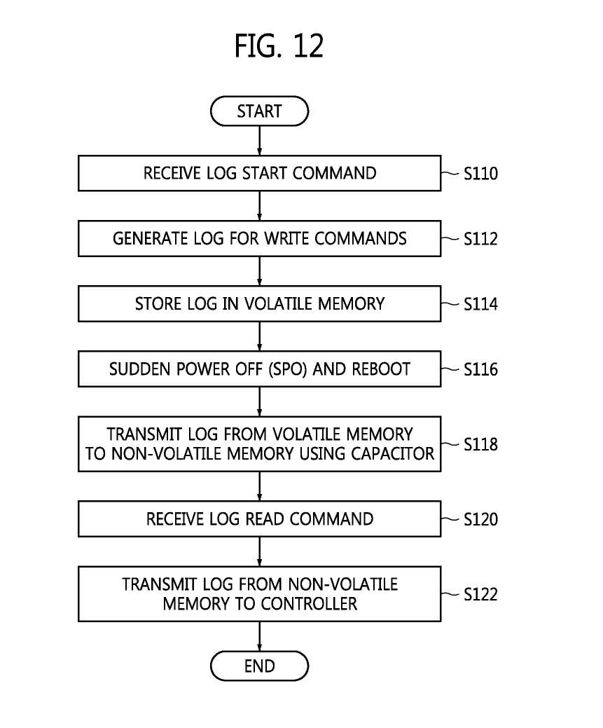

FIG. 12 is a flowchart summarizing a method of operating a data storage device according to embodiments of the inventive concept. The structure and operation of related RAID system components are assumed to be substantially the same as those previously described for data storage devices 200, 210-1 through 210-4, and 300, and therefore, the operation of the first data storage device 200 will be described with reference to FIGS. 1, 2, 9, and 12.

The first data storage device 200 receives the log start command SWCL1 from the RAID controller 112 (operation S110). The first data storage device 200 generates the write command log WL1 for write commands output from the RAID controller 112 in response to the log start command SWCL1 (operation S112). For instance, the first memory controller 202-1 may parse the write commands and may generate the write command log WL1 including an LBA and a sector count, which are included in each of the parsed write commands, as shown in FIG. 5A.

The first data storage device 200 stores the write command log WL1 in the first volatile memory 204-1 (operation S114). A SPO event then occurs in relation to the RAID system 100A or 100B (operation S116). When the SPO event occurs, the first data storage device 200 communicates (or transmits) the write command log WL1 stored in the first volatile memory 204-1 to the first non-volatile memory 206-1 using (e.g.,) a residual operating voltage derived from charge store in the first capacitor C1 (operation S118).

The first data storage device 200 receives the log read command RWCL1 from the RAID controller 112 (operation S120). The first data storage device 200 communicates (or transmits) the write command log WL1 stored in the first non-volatile memory 206-1 to the RAID controller 112 in response to the log read command RWCL1 (operation S122).

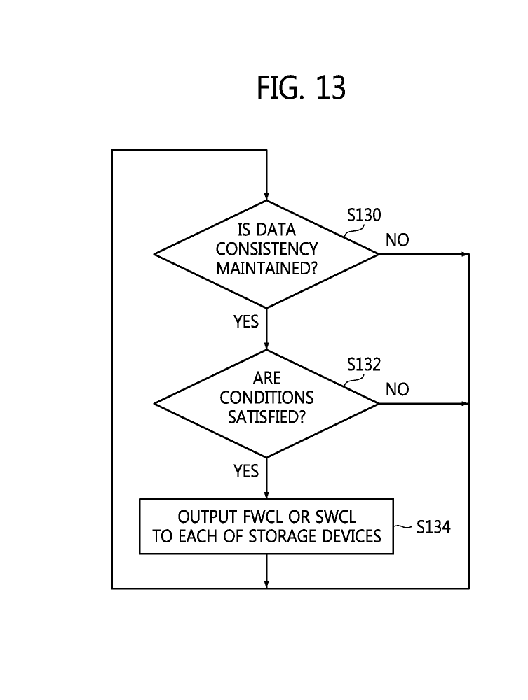

FIG. 13 is a flowchart summarizing a method of generating a log start command and a log finish command according to embodiments of the inventive concept. Referring to FIGS. 1, 2, 4 and 13, the RAID system 100A is now assumed to be a mirroring RAID system. The RAID system 100A communicates each of the write commands W100, W210, and W180 to both data storage devices 200 and 300 simultaneously.

After the log start commands SWCL1 and SWCL2 are respectively output to the data storage devices 200 and 300, when data consistency between the data storage devices 200 and 300 is maintained (operation S130), the RAID controller 112 may determine the output timing of each of the log finish commands FWCL1 and FWCL2.

The RAID controller 112 may determine the output timing of each of the log finish commands FWCL1 and FWCL2 according to the size of a write command log (or the number of write commands in the log) generated in corresponding one of the data storage devices 200 and 300 (operation S132). For instance, the size of the write command log WL1 or WL2 may be calculated based on the number of write commands communicated to the data storage device 200 or 300. Alternatively, the RAID controller 112 may determine the output timing of each of the log finish commands FWCL1 and FWCL2 according to how much time has elapsed since the log start command SWCL1 or SWCL2 was output to the data storage device 200 or 300 (operation S132).

When the log start commands SWCL1 and SWCL2 are respectively output to the data storage devices 200 and 300, data consistency between the data storage devices 200 and 300 is maintained, and conditions are satisfied in operation S132; the RAID controller 112 outputs the log finish commands FWCL1 and FWCL2 to the data storage devices 200 and 300, respectively, in operation S134. Then, the write command logs WL1 and WL2 are respectively deleted from the volatile memories 204-1 and 204-2 included in the respective data storage devices 200 and 300. That is, each of the data storage devices 200 and 300 may halt generation of a log for write commands and delete the log that has been generated in response to the log finish command FWCL1 or FWCL2.

After outputting the log finish commands FWCL1 and FWCL2 to the respective data storage devices 200 and 300, the RAID controller 112 outputs the log start commands SWCL1 and SWCL2 to the data storage devices 200 and 300, respectively. The data storage devices 200 and 300 prepare or start to generate a log for write commands in response to the log start commands SWCL1 and SWCL2, respectively. That is, the RAID controller 112 is able to adequately adjust the output timing of the log finish commands FWCL1 and FWCL2.

In some embodiments, the RAID controller 112 may output a command for performing functions of both a log finish command and a log start command. Thus, each of the data storage devices 200 and 300 may delete a write command log and then immediately prepare to generate a log for a new write command in response to one command.

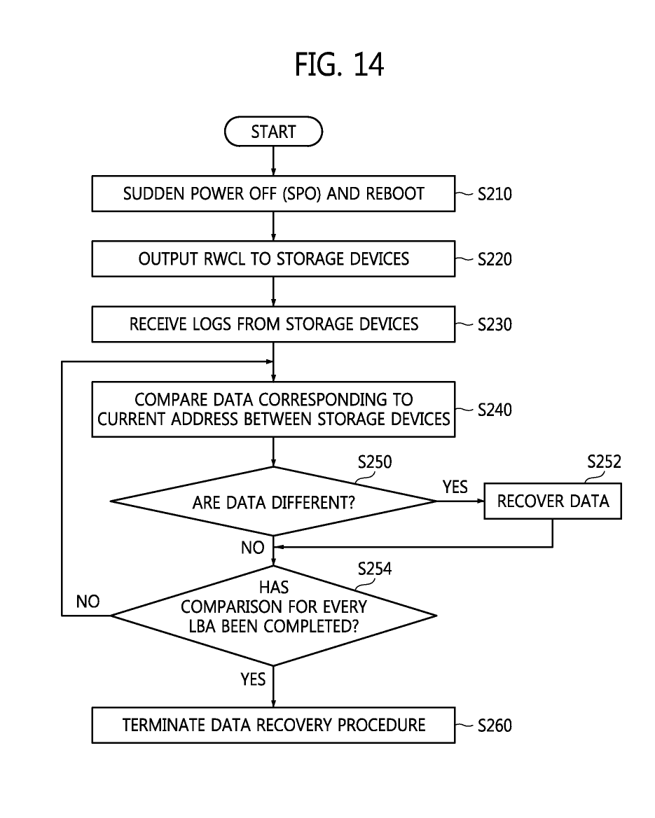

FIG. 14 is a flowchart summarizing a method of operating the RAID system 100A of FIG. 1 according to embodiments of the inventive concept. The operation of the RAID system 100A as the RAID system 100A is rebooted following a SPO event will be described with reference to FIGS. 1, 2, 4, and 14.

Thus, a SPO event occurs in the RAID system 100A and the RAID system 100A is rebooted (operation S210). The RAID controller 112 outputs the log read commands RWCL1 and RWCL2 to the data storage devices 200 and 300, respectively, (operation S220).

The RAID controller 112 receive the write command logs WL1(100, 210) and WL2(100, 210) from the respective data storage devices 200 and 300 (operation S230). The RAID controller 112 reads the data RD100 corresponding to LBA100 from the data storage devices 200 and 300, respectively, based on the write command logs WL1(100, 210) and WL2(100, 210) and compares the data RD100 read from the first data storage device 200 with the data RD100 read from the second data storage device 300 (operation S240). When the data RD100 that have been read are the same as each other (operation S250), the RAID controller 112 determines whether LBA100 is the last LBA for resynchronization based on the write command logs WL1(100, 210) and WL2(100, 210) (operation S254).

When LBA100 is not the last LBA (operation S254), the RAID controller 112 reads the data RD210 and RD210′ corresponding to LBA210 from the data storage devices 200 and 300, respectively, based on the write command logs WL1(100, 210) and WL2(100, 210) and compares the data RD210 read from the first data storage device 200 with the data RD210′ read from the second data storage device 300 (operation S240). When the data RD210 and RD210′ that have been read are different from each other (operation S250), the RAID controller 112 copies data (i.e., write data included in the write command W210) stored in the first data storage device 200 to the second data storage device 300 in operation S252. Thus, the RAID controller 112 performs data recovery (operation S252).

After the data recovery is completed, the RAID controller 112 determines whether LBA210 is the last LBA based on the write command logs WL1(100, 210) and WL2(100, 210) (operation S254). When the LBA210 is the last LBA for resynchronization, the data recovery procedure is terminated (operation S260). The operation of the RAID system 100B illustrated in FIG. 9 is assumed to be substantially the same as that of the RAID system 100A illustrated in FIG. 1. Therefore, the flowchart of FIG. 14 may also be applied to the RAID system 100B of FIG. 9.

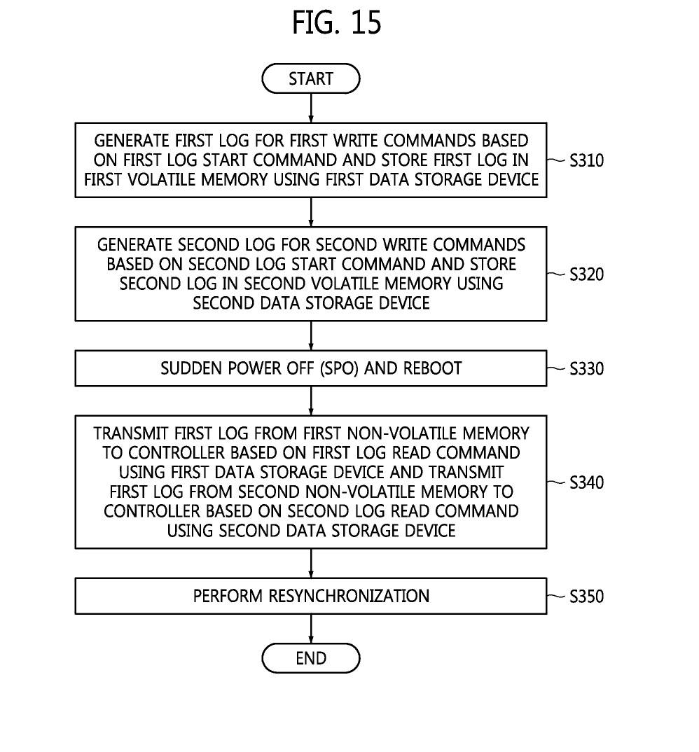

FIG. 15 is a flowchart summarizing a method of operating the RAID system 100A of FIG. 1 according to embodiments of the inventive concept. Referring to FIGS. 1, 2 and 15, the first data storage device 200 generates the first write command log WL1 for first write commands in response to the first log start command SWCL1 output from the RAID controller 112 and stores the first write command log WL1 in the first volatile memory 204-1 (operation S310). The second data storage device 300 generates the second write command log WL2 for second write commands in response to the second log start command SWCL2 output from the RAID controller 112 and stores the second write command log WL2 in the second volatile memory 204-2 (operation S320). In certain embodiments of the inventive concept, operations S310 and S320 may be performed simultaneously, or operation S320 may be performed before operation S310.

A SPO event now occurs in the RAID system 100A, and as a result the RAID system 100A is rebooted (operation S330). When the SPO event occurs, the first memory controller 202-1 stores the first write command log WL1 stored in the first volatile memory 204-1 in the first non-volatile memory 206-1 using a residual operating voltage derived from charge stored in the first capacitor C1. In addition, the second memory controller 202-2 stores the second write command log WL2 stored in the second volatile memory 204-2 in the second non-volatile memory 206-2 using a residual voltage derived from charge stored in the second capacitor C2.

The first data storage device 200 communicates (or transmits) the first write command log WL1 stored in the first non-volatile memory 206-1 to the RAID controller 112 in response to the first log read command RWCL1 output from the RAID controller 112 (operation S340). In addition, the second data storage device 300 communicates the second write command log WL2 stored in the second non-volatile memory 206-2 to the RAID controller 112 in response to the second log read command RWCL2 output from the RAID controller 112 (operation S340).

The RAID controller 112 performs resynchronization using the first write command log WL1 and/or the second write command log WL2 (operation S350). That is, the latest data in the first data storage device 200 is communicated to the second data storage device 300, and the latest data in the second data storage device 300 is communicated to the first data storage device 200.

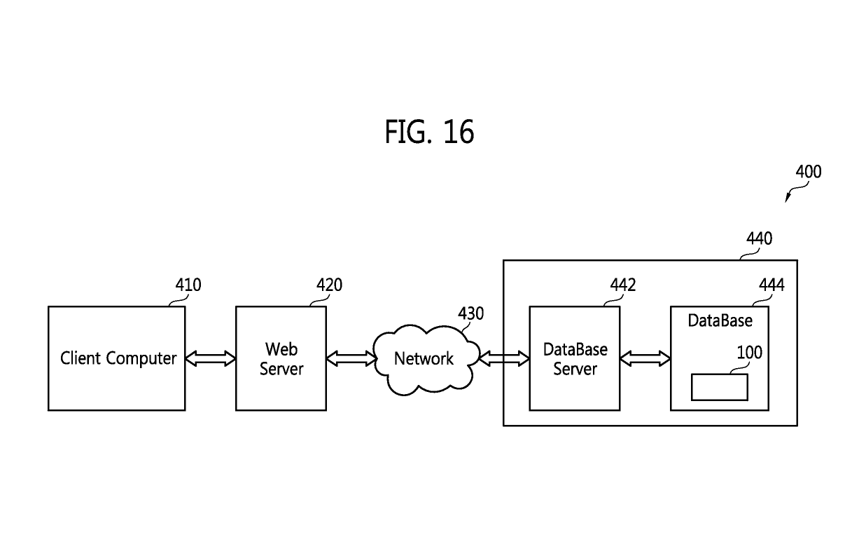

FIG. 16 is a block diagram illustrating a data processing system 400 including the RAID system 100A or 100B of FIGS. 1 and/or 9. Referring to FIG. 16, the data processing system 400 includes a client computer 410, a web server 420, a network 430, and a data processor 440. The data processor 440 includes a database server 442 and a database 444. The data processing system 400 may be a search portal or an internet data center (IDC).

The client computer 410 may communicate data to and receive data from the web server 420 via a network. The client computer 410 may be implemented as a personal computer (PC), a laptop computer, a smart phone, a tablet PC, a personal digital assistant (PDA), a mobile internet device (MID), or a wearable computer.

The web server 420 may communicate commands and/or data with the database server 442 via the network 430. The database server 442 may function as the control unit 110 illustrated in FIG. 1 or 9. The database server 442 may also function as a host that can communicate commands and/or data with the control unit 110 illustrated in FIG. 1.

The database server 442 may control the operations of the database 444. The database server 442 may access the database 444. The database 444 may include a plurality of RAID systems 100A or 100B (collectively denoted by reference numeral 100).

The web server 420 and the database server 442 may communicate commands and/or data with each other via the network 430. The network 430 may be a wired network, a wireless network, internet, an intranet, or a cellular network.

As described above, according to certain embodiments of the inventive concept, a method of operating a data storage device uses a log for write commands to quickly and efficiently recover data when a SPO event occurs in the data storage device. According to the method, a log for write commands output from a controller is generated in response to a log start command output from the controller, and following the SPO event and corresponding reboot, the log is communicated to the controller in response to a log read command output from the controller.

In addition, according to other embodiments of the inventive concept, a method of operating a RAID system enables resynchronization on certain data instead of all data using write command logs output from respective data storage devices, such that latest data may be quickly identified. As a result, data may be more quickly recovered.

While the inventive concept has been particularly shown and described with reference to embodiments thereof, it will be understood by those of ordinary skill in the art that various changes in forms and details may be made therein without departing from the scope of the inventive concept as defined by the following claims.

What is claimed is:

1. A method of operating a data storage device, the method comprising:
receiving a log start command from a controller;
generating a write command log communicated from the controller in response to the log start command;
storing the write command log in memory;
receiving a log read command from the controller; and
communicating the write command log stored in memory to the controller in response to the log read command.

2. The method of claim 1, wherein the data storage device is one of a hard disk drive (HDD) and a solid state drive (SSD).

3. The method of claim 1, wherein the generating of the write command log comprises for each received write command:
parsing the write command; and
generating an entry in the write command log including a logical block address and a sector counter associated with the write command.

4. The method of claim 1, wherein the memory is one of a volatile memory and a non-volatile memory.

5. The method of claim 4, wherein the memory is a non-volatile memory, and
the storing of the write command log in the memory comprises:
storing the write command log in a volatile memory; and
copying the write command log stored in the volatile memory to the memory using a residual operating voltage derived from charge stored in a capacitor included in the data storage device when a sudden power off (SPO) event occurs in the data storage device.

6. The method of claim 1, wherein the log read command is received from the controller following reboot of the data storage device caused by a sudden power off (SPO) event.

7. A method of operating a Redundant Array of Independent Disks (RAID) system including a RAID controller and a first data storage device, the method comprising:
receiving a first log start command generated by the controller in the first data storage device;
generating a first write command log for a first write command communicated from the controller to the first data storage device in response to the first log start command;
storing the first write command log in a first memory;
receiving a first log read command from the controller following reboot of the first data storage device or RAID system caused by a sudden power off (SPO) event; and thereafter,
communicating the first write command log stored in the first memory to the controller in response to the first log read command.

8. The method of claim 7, wherein the RAID system includes a central processing unit (CPU), and the RAID controller is a software RAID controller executed by the CPU.

9. The method of claim 7, wherein the RAID controller is a hardware RAID controller implemented on a RAID controller card.

10. The method of claim 7, wherein the generating the first write command log comprises for each first write command:
parsing the first write command; and
generating an entry in the write command log including a logical block address and a sector counter associated with the write command.

11. The method of claim 7, wherein the RAID system further comprises:
a second data storage device, and the first log start command is received in only the first data storage device.

12. The method of claim 11, further comprising:
copying data stored in the first data storage device and related to the first write command to the second data storage device using the first write command log.

13. The method of claim 7, wherein the RAID system further comprises a second data storage device, and the method further comprises:
receiving a second log start command generated by the RAID controller in the second data storage device;
generating a second write command log for a second write command communicated from the RAID controller to the second data storage device in response to the second log start command;
storing the second write command log in a second memory;
receiving a second log read command from the RAID controller following reboot of the second data storage device or RAID system caused by the sudden power off (SPO) event; and thereafter,
communicating the second write command log stored in the second memory to the RAID controller in response to the second log read command.

14. The method of claim 13, further comprising:
copying data stored in the first data storage device and related to a first write command to the second data storage device based on the first write command log; and
copying data stored in the second data storage device and related to a second write command to the first data storage device based on the second write command log.

15. The method of claim 13, wherein each one of the first and second data storage devices is either a hard disk drive (HDD) or a solid state drive (SSD).

16. The method of claim 15, wherein the first data storage device is a HDD and the second data storage device is a SSD.

17. The method of claim 13, wherein the RAID controller generates the first log start command and the second log start command at different times.

18. The method of claim 13, wherein the RAID system is one of a mirroring RAID system and a parity RAID system.

19. A method of operating a Redundant Array of Independent Disks (RAID) system including a RAID controller, a first data storage device, and a second data storage device, the method comprising:
using the first data storage device to generate a first write command log for first write commands communicated from the RAID controller in response to a first log start command received from the RAID controller, and storing the first write command log in a first memory;
using the second data storage device to generate a second write command log for second write commands communicated from the RAID controller in response to a second log start command received from the RAID controller, and storing the second write command log in a second memory;
using the first data storage device to communicate the first log stored in the first memory to the RAID controller in response to a first log read command received from the RAID controller following reboot of the first data storage device caused by a first sudden power off (SPO) event; and
using the second data storage device to communicate the second log stored in the second memory to the RAID controller in response to a second log read command received from the RAID controller following reboot of the second data storage device caused by a second SPO event.

20. The method of claim 19, further comprising:
using the RAID controller to copy data stored in the first data storage device and related to a first write command to the second data storage device based on the first write command log, and copying data stored in the second data storage device and related to a second write command to the first data storage device based on the second write command log.
